(19) United States
(12) Patent Application Publication
(10) Pub. No.: US 2005/0029714 A1
(43) Pub. Date: Feb. 10, 2005

(54) Process for forming tubular member

(75) Inventors: Kenji Miyanaga, Sayama-shi (JP); Manabu Maruyama, Sayama-shi (JP); Izuru Hori, Sayama-shi (JP); Yuji Kanai, Sayama-shi (JP); Kouki Mizutani, Sayama-shi (JP)

Correspondence Address: CARRIER BLACKMAN AND ASSOCIATES, 24101 NOVI ROAD, SUITE 100, NOVI, MI, 48375, US

(73) Assignee: HONDA GIKEN KOGYO KABUSHIKI KAISHA, MINATO-KU (JP)

(21) Appl. No.: 10/492,510

(22) PCT Filed: Oct. 23, 2002
(86) PCT No.: PCT/JP02/11009

(30) Foreign Application Priority Data
Oct. 24, 2001 (JP) 2001-325882

(51) Int. Cl. B29C 43/00

(52) U.S. Cl. 264/573; 264/325

(57) ABSTRACT

A process for forming a tubular member is provided which includes a preforming process for tube-expanding (bulge) forming and bending forming a tubular material (Pa) using first and second molds (M1, M2) and a final forming process for crush forming a preformed tube (Pc) using a third mold (M3) so as to give its cross section a desired shape, the preforming being carried out using the first and second molds (M1, M2) heated at temperatures equal to or higher than the recrystallization temperature of the tubular material and the final forming being carried out using the third mold (M3) heated at temperatures equal to or lower than the recrystallization temperature of the tubular material. The process enables a tubular material of aluminium alloy to be formed into a tubular member of high precision and high quality which has expanded portions as well as bent portions and whose cross section varies across its length. The process also enables drastic increase in productivity.

### FIELD OF THE INVENTION

The present invention relates to a process for forming a tubular member which enables a tubular member of high precision to be formed from a tubular metal material by hot forming the material using a preforming mold, which is kept at temperatures equal to or higher than the recrystallization temperature of the material, in combination with a final forming mold, which is kept at temperatures equal to or lower than the recrystallization temperature of the same.

### BACKGROUND ART

Conventionally, bulge process has been known as one of the technical means of press forming for forming a tubular metal material into a tubular member of a deformed cross section having expanded portions in the appropriate places across its length. The bulge process is a process for forming a tubular material into a desired form by mold clamping a mold in which the tubular material is set and then applying an internal pressure by fluid pressure to the interior of the tubular material to allow the material to expand and fit on the surface of the mold cavity. And such a conventional bulge process is usually carried out by cold forming at, for example, room temperature.

The cold bulging, however, has a problem of its processability being poor because it requires a very high pressure to be applied to the interior of the tubular material to be processed, and therefore, needing large-scale equipment, as a result, making it hard to process materials of high strength.

To overcome such a problem, there have been proposed various hot bulging means where bulging is carried out while heating a forming mold (see Japanese Patent Application Laid-open No. 62-270229, Japanese Patent Application Laid-open No. 62-259623 and Japanese Patent Application Laid-open No. 62-259624). In these hot bulging means, both heating function and cooling function are provided to the mold itself, so that the material set in the mold is heated, swelled when a pressure is applied to its inside, while the mold is cooled to prevent its overheating, the material is prevented from swelling more than necessary and the mold itself is prevented from fracturing.

In conventional hot bulging means, however, their heat efficiency is poor, and besides, they cause deterioration in mold in the early stage of its use because heating and cooling in the same mold are repeated. Furthermore, they have a problem of taking a long time to form a product, depending on a shape of the product, and being poor in precision and thus being unsuitable for forming a tubular member, which is required to be of high precision and of high quality, because a sequence of forming steps are completed in one mold.

### DISCLOSURE OF THE INVENTION

The present invention has been made in the light of the above-mentioned circumstances. Accordingly, the object of the invention is to provide a novel process for forming a tubular member which enables a tubular member, as an end product, of high quality and high precision to be formed from a tubular member by hot preforming the tubular material using a preforming mold, kept at temperatures equal to or higher than the recrystallization temperature of the material, and hot final forming the preformed material using a final forming mold, kept at temperatures equal to or lower than the recrystallization temperature of the material and which drastically increases the productivity.

In order to accomplish the above-mentioned object, in accordance with a first aspect of the invention, there is proposed a process for forming a tubular member which forms a tubular material into a desired shape while applying an internal pressure to the material, the process including: a preforming step of preforming a preformed tube from the tubular material by setting the material into the cavity of a preforming mold and mold clamping the preforming mold while applying an internal pressure to the material; and a final forming step of final forming the preformed tube into a tubular member having a cross section of desired shape by setting the preformed tube into the cavity of a final forming mold and mold clamping the final forming mold while applying a predetermined internal pressure to the preformed tube, wherein the temperature of the preforming mold, in which preforming is carried out, is controlled so that the mold is kept at temperatures equal to or higher than the recrystallization temperature of the tubular material, while the temperature of the final forming mold, in which final forming is carried out, is controlled so that the mold is kept at temperatures equal to or lower than the recrystallization temperature of the performed tube.

In accordance with this first aspect, a tubular member of high precision and high quality can be formed and the productivity is drastically increased because forming of a tubular material is divided into two steps: a hot preforming step using a preforming mold kept at temperatures equal to or higher than the recrystallization temperature of the material; and a hot final forming step using a final forming mold kept at temperatures equal to or lower than the recrystallization temperature of the material.

In order to accomplish the above-mentioned object, in accordance with a second aspect of the invention in addition to the first aspect, there is proposed a process for forming a tubular member, wherein the preforming is tube-expanding forming.

In accordance with this second aspect, in particular, a tubular member having expanded portions can be formed with high precision and high quality and the productivity is drastically increased.

In order to accomplish the above-mentioned object, in accordance with a third aspect of the invention in addition to the first aspect, there is proposed a process for forming a tubular member, wherein the preforming is tube-expanding forming and bending forming.

In accordance with this third aspect, in particular, a tubular member having expanded portions and bent portions can be formed with high precision and high quality and the productivity is drastically increased.

### BRIEF DESCRIPTION OF THE DRAWINGS

FIGS. 1A and 1B are perspective views of a tubular material after tube-expanding (bulge) forming and a tubular member after completion of forming, respectively;

FIG. 2 is a diagram showing production steps of producing a tubular member by hot forming according to the present invention;

FIG. 3 is a view in cross section along the line 3-3 of FIG. 2;

FIG. 4 is a view in cross section along the line 4-4 of FIG. 2;

FIG. 5 is a view in cross section along the line 5-5 of FIG. 2;

FIG. 6 is an enlarged view in cross section along the line 6-6 of FIG. 5; and

FIG. 7 is a view showing the state in which a tubular material undergoes axial heat shrinkage at a final forming step.

### BEST MODE FOR CARRYING OUT THE INVENTION

In the following the embodiment of this invention will be described in detail based on an embodiment illustrated in the accompanying drawings.

A tubular material Pa formed in accordance with the forming process of this embodiment is a hollow cylindrical material of aluminium alloy with both its ends open, and it is heated to about 500° C. by heating means before being carried in a first mold M1 for preforming. As heating means, electric heating is employed in this embodiment, but heating may also be carried out in a furnace.

A forming process according to this embodiment includes:

(1) a preforming step of the tubular material [tube-expanding forming (bulge-forming) step and bending step];

(2) a final forming step of forming a preformed tube, which is the tubular material after preforming, into a tubular member of final shape

and a sequence of the above forming is carried out continuously in first, second and third molds M1, M2 and M3 described later.

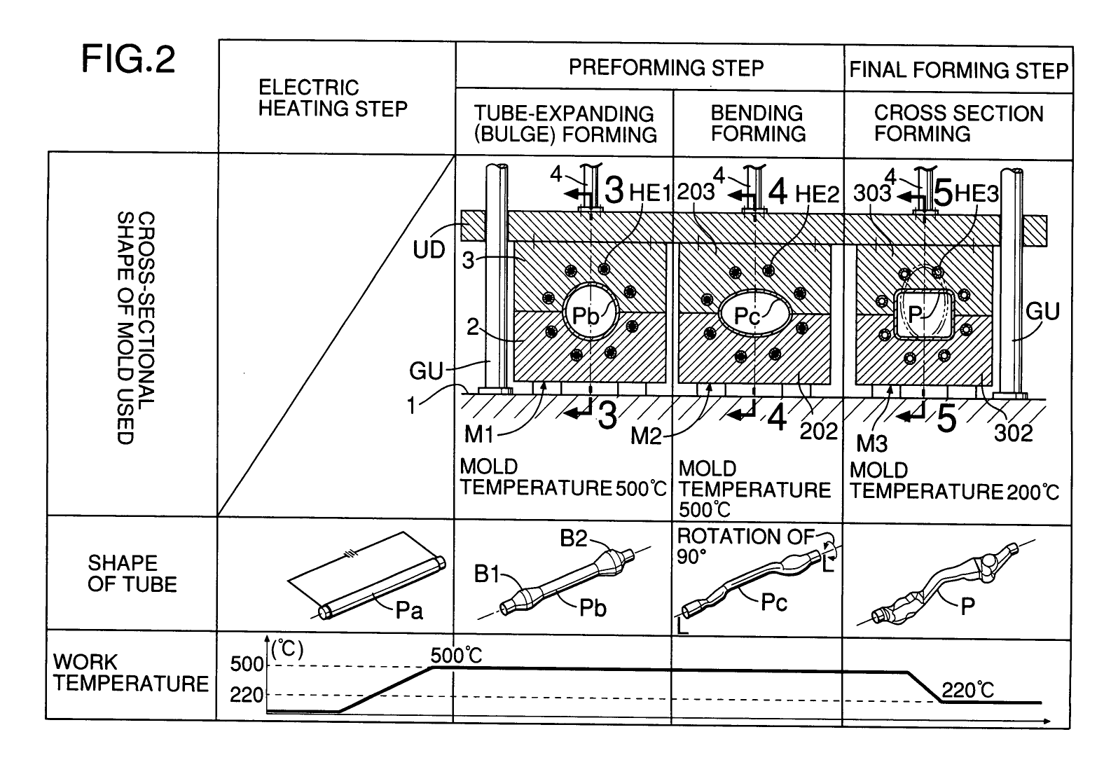

As shown in FIG. 2, the first, second and third molds M1, M2 and M3 are arranged in parallel on a base 1 and the first and second molds M1 and M2 are used in the preforming step of preforming the tubular material and the third mold M3 in the final forming step of forming the preformed tube.

The first, second and third molds M1, M2 and M3 are formed of stationary molds 2, 202, 302 mounted fixedly in line on a base 1 and moving molds 3, 203, 303, which correspond to the respective stationary molds; the moving molds 3, 203, 303 are integrally connected to an up-and-down member UD which extends over the moving molds; to the up-and-down member UD an up-and-down cylinder 4 as a mold clamping cylinder is connected; and the first, second and third moving molds 3, 203, 303 are synchronized and allowed to perform up-and-down action by the expansion action of the up-and-down cylinder 4. Between the base 1 and the up-and-down member UD a guide GU is provided and the guide GU guides the up-and-down movement of the up-and-down member UD.

The first mold M1 is a tube-expanding forming mold for carrying out hot tube-expanding forming (hot bulge-forming) at temperatures equal to or higher than the recrystallization temperature of a hollow cylindrical tubular material of aluminium alloy (hereinafter referred to as a tubular material Pa), which is heated to and kept at about 500° C. in advance, and in the tube-expanding forming mold, conventionally known heating means such as high-frequency-current heating means, heater heating means or the like is used as heating means HE1 for heating the mold to about 500° C.

The second mold M2 is a bending forming mold for carrying out hot bending forming at temperatures equal to or higher than the recrystallization temperature of the expanded tubular material formed in the first mold M1 (hereinafter referred to as a tubular material Pb), and also in the bending forming mold M2, heating means HE2 for heating the mold M2 to about 500° C., for example, high-frequency-current heating means is provided, just like in the case of the first mold M1. High-frequency-current heating means, heater heating means and the other conventionally known heating means are used as heating means HE1.

The preforming step according to the present invention is formed of the hot tube-expanding forming (hot bulge-forming) step and the hot bending forming step in combination.

The third mold M3 is a final forming mold for carrying out cross-section forming by crushing the tubular material(hereinafter referred to as tubular material Pc) having undergone hot tube-expanding forming (bulging) and hot bending forming in the first and second molds M1, M2, respectively, into a desired shape at temperatures equal to or lower than the recrystallization temperature of the tubular material Pc, and in the final forming mold M3, heating means HE3 for heating the mold M3 to about 200° C., for example, fluid heating means is provided. Since the tubular material Pc is still in the heated state (preformed at about 500° C.), when it is set in the third mold M3, heat is transferred from the tubular material Pc to the third mold M3, which is kept at temperatures equal to or lower than the recrystallization temperature of the tubular material Pc, and thus the tubular material Pc undergoes hot final forming in the third mold M3 while being controlled so that its temperature is rather decreased.

Then the above-mentioned steps are described in detail in order.

(1) Step of Subjecting the Tubular Material Pa to Tube-Expanding (Bulge) Forming (First Step)

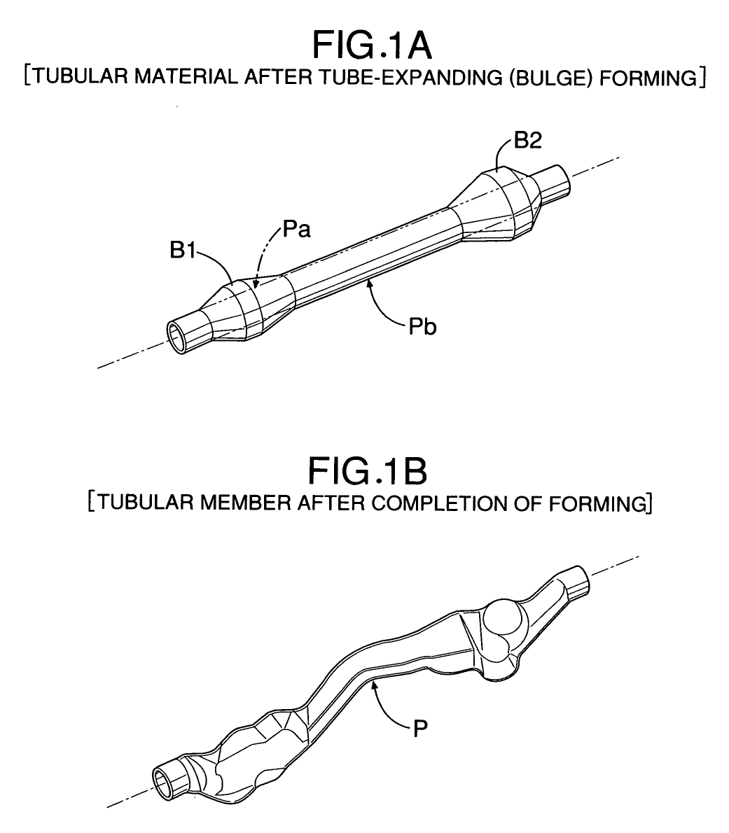

The tubular material of aluminium alloy (hereinafter referred to as tubular material Pa) heated to about 500° C. in advance is carried to the first mold M1 and introduced into the first mold M1 which has also been heated to about 500° C., that is, the temperature equal to or higher than the recrystallization temperature of the tubular material Pa, and part of the tubular material Pa in a state of being kept at the temperature equal to or higher than the recrystallization temperature, in this embodiment the sites B1, B2 near its opposite ends (see FIG. 1A), undergo hot tube-expanding forming (hot bulgeforming).

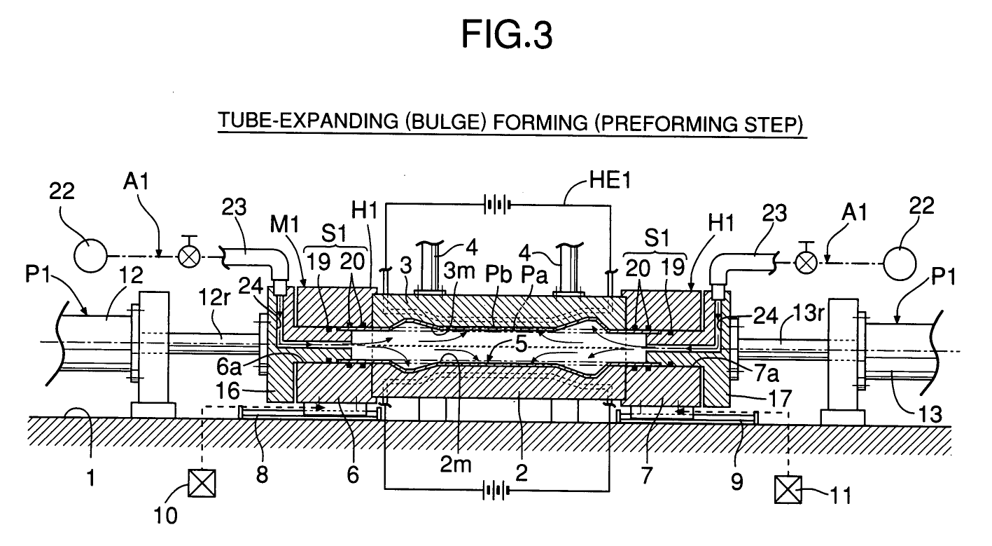

As shown in FIG. 3, the first mold M1 includes a stationary mold on the base 1, that is, a lower mold 2 and a moving mold, that is, an upper mold 3 whose up-and-down action above the lower mold 2 is controlled by the action of the up-and-down cylinder 4; on the top surface of the lower mold 2 is formed a lower mold forming surface 2m for forming the lower half of the tubular material Pa; on the bottom surface of the upper mold 3 is formed an upper mold forming surface 3m for forming the upper half of the tubular material Pa; and when mold clamping the first mold M1, the forming surfaces 2m and 3m form a cavity 5. On opposite sides of the first mold M1 are provided hold means H1 for fixing opposite ends of the tubular material Pa. The hold means H1 are each provided with left and right holders 6, 7 on each side of the first mold M1, and the holders 6, 7 are movable back and forth relative to the first mold M1 and their movement on guides 8, 9, which are provided on the base 1, is controlled by the operation of actuators 10, 11. The opposite end portions of the tubular material Pa are fitted and fixed into the supporting holes 6a, 7a of the left and right holders 6, 7 by the forward movement thereof.

On the opposite sides of the first mold M1 are provided pressing means P1 for pressing from the axial direction the tubular material Pa set in the mold M1. The pressing means P1 include left and right pressing cylinders 12, 13, respectively; pressing members 16, 17 fixed on the tip of the rod portions 12r, 13r of the pressing cylinder 12, 13 are fitted into the support hole 6a, 7a of the left and right holders 6, 7 in the back and forth movable manner; the tips of the pressing members 16, 17 are respectively engaged with the opposite ends of the tubular material Pa by the extension action of the left and right pressing cylinders 12, 13; and the tubular material Pa can be axially pressed from its opposite sides by the subsequent forward movement of the pressing members 16, 17.

Between the left and right pressing members 16, 17 and the supporting holes 6a, 7a and between the supporting holes 6a, 7a and outer peripheral surfaces of opposite end portions of the tubular material Pa are provided O rings 19, 20 as sealing means S1, and these O rings 19, 20 can provide a fluid tight seal between the tubular material Pa and the holders 6, 7 and between the tubular material Pa and the pressing members 16, 17, when the pressing members 16, 17 are engaged with the tubular material Pa.

On opposite sides of the first mold M1 are provided compressed air supplying means A1 for pressurizing the inside of the tubular material Pa. The compressed air supplying means A1 are so constructed that they feed compressed air under pressure from compressed air supplying sources 22 to the closed hollow portion of the tubular material Pa via compressed air circuits 23 and air introducing paths 24 pierced in the pressing members 16, 17.

After introducing and setting the tubular material Pa, which has been heated to about 500° C. in the heating step as a pre-step, in the first mold M1, which has also been heated to about 500° C. by the heating means HE1, the first mold M1 is mold clamped by the operation of the mold clamping cylinder 4.

If an extension action are given to the pressing cylinders 12, 13 after fixing opposite ends of the tubular material Pa by means of the forward movement of the left and right holders 6, 7, the rod portions 12r, 13r press the tubular material Pa axially and allow pressurizing air to be fed from the compressed air source 22 into the tubular material Pa via the compressed air supplying path 23 and the air introducing path 24 while carrying out the axial pushing, and an internal pressure is applied to the tubular material Pa. The sites B1, B2 of opposite end portions of the tubular material Pa undergo tube-expanding forming (bulge-forming) so that the tubular material Pa follows the upper and lower forming surfaces 3m, 2m of the cavity 5.

In this case, since the tube-expanding (bulge) forming is hot forming (about 500° C.), the pressure required for the forming is low compared with the case of cold forming, as a result, the forming time is reduced.

The tubular material after tube-expanding forming (hereinafter referred to as tubular material Pb) is drawn out from the first mold M1 by opening the same after allowing the left and right holder 6, 7 to move backward. In the tubular material Pb, the sites B1, B2 near its opposite ends undergo tube-expanding forming (bulge forming), as shown in FIGS. 1A and 2.

(2) Bending Forming Step (Second Step)

The second step is a bending forming step of bending forming the tubular material Pb, which has undergone tube-expanding forming in the previous step.

The tubular material Pb having undergone tube-expanding forming (bulge-forming) in the above-mentioned first step is carried to the second mold M2 by known carrying means with still in the heated state, not shown in the figure, and set in the same to undergo hot (500° C.) bending forming, which is carried out while applying an internal pressure to the tubular material.

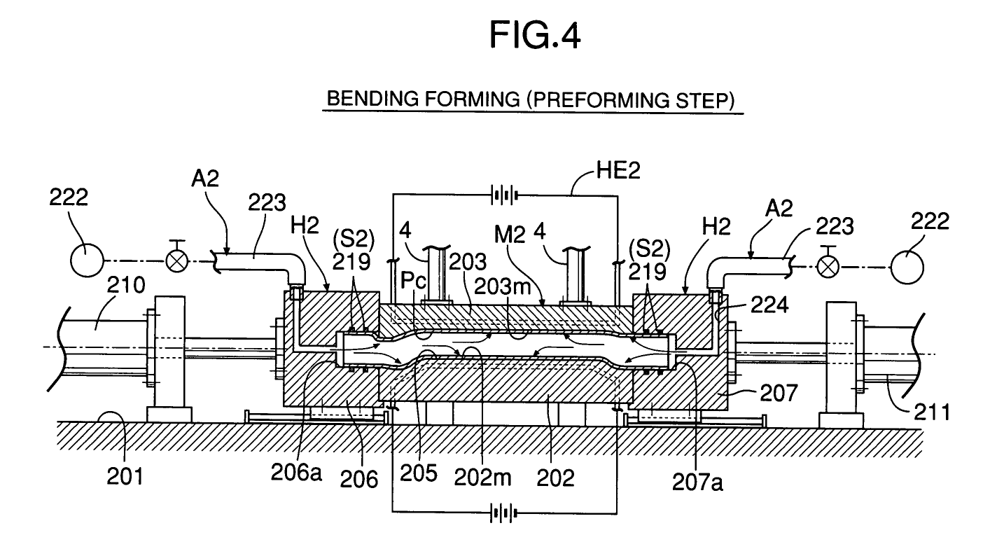

The second mold M2 has almost the same construction as the first mold M1, except that a pressing means P1 is omitted, as shown in FIG. 4. Specifically, the second mold M2 includes a stationary mold on the base 1, that is, a lower mold 202 and a moving mold, that is, an upper mold 203 whose up-and-down action above the lower mold 202 is controlled; on the top surface of the lower mold 202 is formed a lower mold forming surface 202m for bending forming the lower half of the tubular material Pb; on the bottom surface of the upper mold 203 is formed an upper mold forming surface 203m for bending forming the upper half of the tubular material Pb; and when mold clamping the second mold M2, the forming surfaces 202m and 203m form a cavity 205. On opposite sides of the second mold M2 are provided hold means H2 for fixing opposite ends of the tubular material Pb, just like in the case of the first mold M1. The hold means H2 are each provided with left and right holders 206, 207, and the back and forth movement of the holders 206, 207 relative to the second mold 2 is controlled by actuators 210, 211 which are formed of expansion cylinders. To the supporting holes 206a, 207a of the holders 206, 207 are provided sealing means S2 which are formed of O rings 219 to air-tightly seal opposite open ends of the tubular material Pb.

On opposite sides of the second mold M2 are provided compressed air supplying means A2 for pressurizing the inside of the tubular material Pb. The compressed air supplying means A2 are so constructed that they feed compressed air under pressure from compressed air supplying sources 222 to the closed hollow portion of the tubular material Pb, which has undergone bulging, via compressed air circuits 223 and air introducing paths 224 pierced in the holders 206, 207.

In this second step, the tubular material Pb having undergone tube-expanding forming (bulge-forming) in the previous step, which is still in the heated state, is introduced into the second mold M2 in the opened state, which has been heated to about 500° C. by the heating means HE2, and set in the same. Then opposite end portions of the tubular material Pb are held in the second mold M2 by allowing the left and right holders 206, 207 to take a forward action by the operation of the actuators 210, 211, and at the same time, the open ends are air-tightly sealed by the sealing means S2. Then an internal pressure is applied to the tubular material Pb by feeding pressurizing air under pressure from the compressed air sources 222 into the tubular material Pb via the compressed air supplying paths 223 and the air introducing paths 224 and the second mold M2 is mold clamped by allowing the upper mold 203 to descend by the operation of the mold clamping cylinder 4 to allow the tubular material Pb, which has undergone tube-expanding (bulge) forming, to fit to the bending forming surfaces 203m, 202m of the upper and lower molds 203, 202, and hot (about 500° C.) bending is carried out in such a state.

The tubular material having undergone this bending forming, that is, a preformed tube (hereinafter referred to as tubular material Pc) has its middle portion bended, as shown in FIG. 1B, and its cross section takes the form of an oval crushed upwards and downwards.

The preforming step following the present invention is thus made up of the tube-expanding forming (bulge forming) step and the bending forming step. This preforming step enables the speeding up of the forming, reduction of the forming pressure, downsizing of the forming equipment and simplification of the forming equipment structure compared with the cold forming, since it is hot forming carried out at temperatures equal to or higher than the recrystallization temperature (about 500° C.) of the tubular material.

(3) Cross-Section Forming Step (Third Step)

This step is a cross-section forming step (final forming step) in which the cross section of the tubular material Pc, which has undergone bending forming, is formed into a final completed shape. In this cross-section forming step, the tubular material Pc, which has undergone tube-expanding forming (bulge forming) and bending forming in the first and second steps and is still in the heated state, is introduced into the third mold M3 by known carrying means, not shown in the figure, and set in the same to undergo cross-section forming.

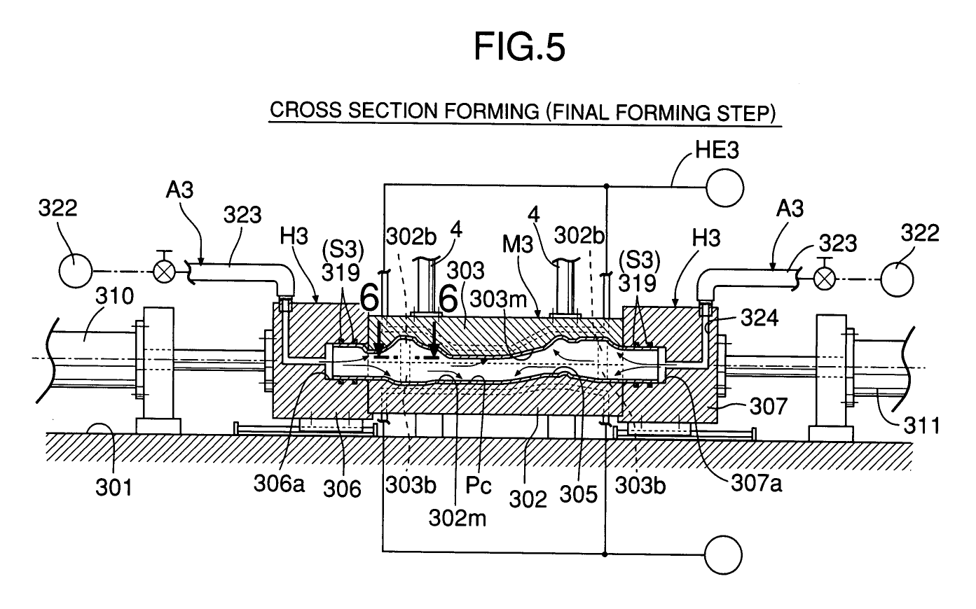

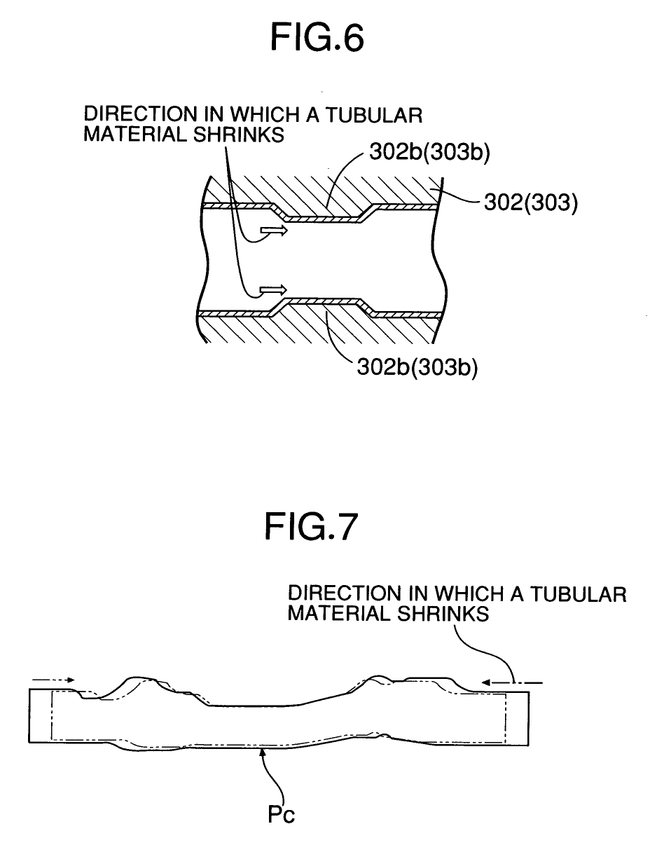

The third mold M3 has substantially the same construction as the second mold M2. As shown in FIGS. 5, 6, it includes a stationary lower mold 302 and an upper mold 303 whose up-and-down action above the lower mold 302 is controlled, and on the top surface of the lower mold 302 and on the bottom surface of the upper mold 303 are formed forming surfaces 302m, 303m for forming the cross section of the tubular material Pc, respectively. When the third mold M3 is mold clamped, the forming surfaces 302m and 303m form a cavity 305 for cross-section forming.

On opposite sides of the forming surfaces 303m, 302m, as shown in FIG. 6, 302m are formed constraining beads 302b, 303b, respectively, and these constraining beads 302b, 303b are engaged with opposite ends of the tubular material Pc in the final forming step to constrain the axial shrinkage of the tubular material Pc during the final forming.

On opposite sides of the third mold M3 are provided hold means H3 for fixing opposite ends of the tubular material Pc, which has undergone bending forming. The hold means H3 are each provided with left and right holder 306, 307, and the back and forth movement of the holders 306, 307 relative to the third mold M3 is controlled by actuators 310, 311 which are made up of expansion cylinders. To the supporting holes 306a, 307a of the holders 306, 307 are provided sealing means S3 which are made up of O rings 319 to air-tightly seal opposite open ends of the tubular material Pc.

On opposite sides of the third mold M3 are provided compressed air supplying means A3 for pressurizing the inside of the tubular material Pc. The compressed air supplying means A3 are so constructed that they feed compressed air under pressure from compressed air supplying sources 322 to the closed hollow portion of the tubular material Pc, which has undergone bending forming, via compressed air circuits 323 and air introducing paths 324 pierced in the holders 306, 307.

The third mold M3 is kept at about 200° C. by heating means HE3. Since the tubular material (preformed tube) Pc, which has undergone bending forming at the second step, is still in the heated state (formed at about 500° C.), when it is set in the third mold M3, heat is transferred from the tubular material Pc to the third mold M3. As a result, the temperature of the mold is increased, but on the other hand, the tubular material Pc is controlled so that its temperature is decreased. Thus, the tubular material Pc, which is formed into an end product shape using the third mold, is not affected by the heat of the third mold M3 and prevented from deforming by heat in the third mold M3.

The tubular material Pc, which has undergone bending forming (preforming) in the second mold M2, is rotated around the axis L-L at about 90° (the angle varies depending on the tubular material Pd) by rotating means not shown in the figure, as shown in FIG. 2, and then carried in the third mold M3 in the open state and set in the same. After this, opposite end portions of the tubular material Pc are fixed in the third mold M3 by the forward movement of the holders 306, 307, and at the same time, they are provided with a fluid tight seal by sealing means S3, and the holder 306, 307 are moved forward. Then the upper mold 303 is allowed to descend by the operation of the mold clamping cylinder 4 to mold clamp the third mold M3, an internal pressure is applied to the inside of the tubular material Pc by compressed air supplying means A3, and load is applied to the tubular material Pc in such a state from the direction orthogonal to the length of the tubular material Pc to crush the cross section of the tubular material so that the material to fit to the forming surfaces of the upper and lower molds 303, 302. Thus the tubular material Pc undergoes cross-section forming and is formed into a final completed shape having, for example, rectangular cross section with small R corner portions. In this forming, the third mold M3 is kept at about 200° C., that is, at the temperature equal to or lower than the recrystallization temperature of the tubular material (preformed tube) Pc, while the tubular material Pc is kept at the temperature (about 500° C.) higher than that of the third mold M3 (about 200° C.), and therefore, hot forming of the tubular material Pc is substantially possible even in the third mold M3, which is kept at temperatures equal to or lower than the recrystallization temperature of the tubular material Pc. Accordingly, the tubular material Pc is not affected and deformed by heat from the third mold M3. In addition, its axial heat shrinkage is constrained since its opposite end portions are engaged with the above-mentioned constraining beads 302b, 303b by the mold clamping of the third mold M3. Thus forming can be carried out while avoiding the external influences on the tubular material Pc and inhibiting the material from the axial heat shrinking in the third mold M3.

The final cross-section forming is carried out while keeping the temperature of the third mold M3 equal to or lower than the recrystallization temperature of the tubular material Pc, and then the tubular material Pc is cooled while keeping the mold M3 in the mold clamped state for a specified period of time.

This operation inhibits variation in shrinkage of the tubular material Pc which is created by cooling when the material is drawn out of the third mold M3 after the final forming. The operation also prevents the tubular material Pc from deforming which is caused when the material is handled, in other words, when the tubular member P shown in FIG. 1B is drawn out of the third mold M3 while opening the same. Furthermore, the tubular member P is not deformed by the external conditions such as air cooling after it is drawn out from the mold.

The combination of the first to third steps, specifically, the combination of the hot preforming using the first and second molds M2, M3 at temperatures equal to or higher than the recrystallization of the tubular material and the hot final forming using the third mold M3 at temperatures equal to or lower than the recrystallization of the tubular material enables formation of a tubular member P which is free from variation in precision, of high precision and of high quality, and besides, drastic increase in the productivity.

Thus, the tubular member P, as an end product, formed in the first to third steps is used as a frame member, etc for vehicles.

Although the embodiment of the present invention has been described in detail, it will be understood that the present invention is not limited to the above-described embodiment, and various modifications in design may be made without departing from the subject matter of the invention defined in the claims.

For example, in the above embodiment, the forming process of this invention is applied to the case where a tubular material is aluminium alloy, but it is without saying that the process can also be applied to tubular materials of other metals. In such a case, the temperatures of heating tubular materials and molds are controlled depending on the material used. In this embodiment, air is used as compressed fluid for applying an internal pressure to the tubular material, other fluids can also be used as long as they produce the same effect.

1. A process for forming a tubular member which forms a tubular material into a desired shape while applying an internal pressure to the material, comprising:
a preforming step of preforming tubular materials (Pa, Pb) into a preformed tube (Pc) by setting the materials (Pa, Pb) into the cavities (5, 205) of preforming molds (M1, M2) and mold clamping the preforming molds (M1, M2) while applying an internal pressure to the materials (Pa, Pb); and
a final forming step of final forming the preformed tube (Pc) into a tubular member (P) having a cross section of desired shape by setting the preformed tube (Pc) into the cavity (305) of a final forming mold (M3) and mold clamping the final forming mold (M3) while applying a predetermined internal pressure to the preformed tube (Pc), wherein
the temperature of the molds is controlled so that the preforming molds (M1, M2) for carrying out preforming are kept at temperatures equal to or higher than the recrystallization temperature of the tubular materials (Pa, Pb), while the final forming mold (M3) for carrying out final forming is kept at temperatures equal to or lower than the recrystallization temperature of the preformed tube (Pc).

2. The process for forming a tubular member according to claim 1, wherein the preforming is tube-expanding forming.

3. The process for forming a tubular member according to claim 1, wherein the preforming is tube-expanding forming and bending forming.
